(19) United States
(12) Patent Application Publication
(10) Pub. No.: US 2006/0173741 A1
(43) Pub. Date: Aug. 3, 2006

(54) Permission-based marketing method and system

(76) Inventor: James C. Marshal, Melbourne, FL (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/296,869

(22) Filed: Dec. 8, 2005

Related U.S. Application Data
(60) Provisional application No. 60/634,821, filed on Dec. 10, 2004.

(51) Int. Cl. G06Q 30/00

(52) U.S. Cl. 705/14

(57) ABSTRACT

A permission-based marketing system for selling goods and services wherein a consumer requests one or more sellers to present proposals for the consumer to purchase a particular item and the opportunity to respond to the request for these proposals is advertised and sold to sellers for a fee. A portion of the fee paid for the opportunity to respond to the request is paid to the consumer. A system which performs the permission-based marketing method is also provided as well as a World Wide Web portal site and a method for interacting with this portal site.

This application claims the benefit of the filing date of U.S. Provisional Application Serial No. 60/634,821 filed Dec. 10, 2004 which is incorporated by reference herein.

### FIELD OF THE INVENTION

This invention relates to a permission-based method and system of marketing via the World Wide Web, direct mail, commercials, sales presentations or telephone.

### BACKGROUND OF THE INVENTION

Conventional marketing methods such as telemarketing, direct mail, television ads, electronic mail (Spam) and pop-up ads, each have a cost associated with acquiring a new customer. This cost varies with the type of business and marketing medium and can be more than $100 per new customer, and may be in excess of $500 per new customer for certain markets. Conventional marketing methods have become less effective as consumers are becoming desensitized to their messages and frustrated by the interruptions at undesirable times for undesirable services. In addition, increased consumer privacy has reduced the supply of consumer information, making it difficult to target marketing efforts to the appropriate population. Furthermore, these conventional marketing methods are faced with ever increasing obstacles by consumers such as call screening technology, caller-ID, and registrations on “no-call” lists. The cost of acquiring a new customer by these conventional techniques is increasing due to these trends.

An ideal marketing method would allow businesses to make their first contact with prospective customers a positive and welcome one, where they would speak only to qualified customers who want their products or services now. Consumers would also like to be left alone until they require a product or service.

As used herein, the following terms are defined to mean:

CONSUMER: A person, partnership, agent or corporation which is willing to give compensation for goods or services.

SELLER: A person, partnership, agent or corporation which offers goods or services for compensation.

CONSUMER ADVERTISEMENT FOR PROPOSALS (CAFP): An offer to receive proposals from sellers for consideration or remuneration, such as a fee or service or other form of compensation that assigned to the offer. Optionally, the offer may have one or more conditions other than consideration or remuneration. The offer is in digital form and is sent by electronic methods which employ computers (world wide web, electronic mail, networks), phones (voice or video phones) and/or cable television.

PERMISSION-BASED MARKETING SYSTEM: A controller that receives and processes a request from a consumer into a Consumer Advertisement For Proposals (CAFP) which, at a minimum, assigns the consideration or remuneration necessary for responding to the CAFP formed from the request. The consideration or remuneration to be assigned can be determined by the permission-based marketing system or it can be input from another source.

GENERAL PURPOSE ACCOUNT: Any account from which a payment can be made, including a credit or debit account or an escrow account.

### BRIEF DESCRIPTION OF THE DRAWINGS

FIGS. 1a and 1b combine to form a flow chart illustrating an embodiment of the permission based marketing method of this invention.

FIG. 2 is a flow chart illustrating the subroutine for evaluating requests from consumers.

FIG. 3 is a schematic representation of a permission based marketing system of this invention.

FIG. 4 is a flow chart illustrating the subroutine for applying the seller's rules.

FIG. 5 is a schematic representation of an embodiment of the central controller used in a permission based marketing system of this invention.

FIG. 6 is a schematic representation of an embodiment of a World Wide Web site portal of this invention.

FIG. 7 is a schematic representation of another embodiment of a World Wide Web site portal of this invention.

FIG. 8 is a flow chart illustrating a method by which a consumer would interact with a World Wide Web site portal of this invention.

FIG. 9 is a flow chart illustrating a method by which a seller would interact with a World Wide Web site portal of this invention.

FIG. 10 is a flow chart illustrating another embodiment of the permission based marketing method of this invention.

FIG. 11 is a printout of an output from the system of this invention, which can be given in real-time, of the number and general location of one or more active CAFPs for a particular product or service.

### DESCRIPTION OF THE INVENTION

The present invention provides a permission based marketing method and a system wherein the opportunity to present offers, proposals or other marketing information to consumers is advertised and sold to suppliers (sellers), with a portion of the sale price (or other form of consideration) going to the consumer. In a preferred embodiment, the price for the opportunity is determined by a demand equation, which can include factors such as the quality of the consumer, the type of product and the price at which the consumer wants to buy the product or service. Also provided are a World Wide Web site portal and a method for interacting with this World Wide Web site portal to perform all or a part of a permission based marketing method consistent with this invention. The invention further provides a database of consumers and/or sellers rated by their past performance using the method and system of this invention.

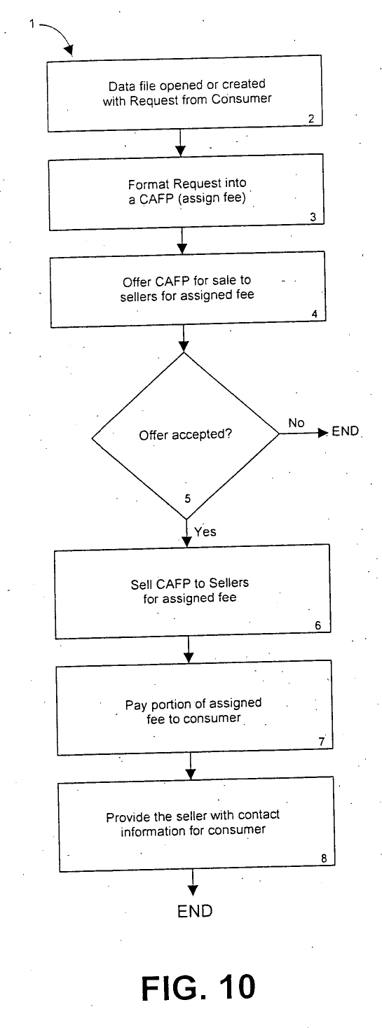

There is provided by this invention a method for marketing an item as shown in FIG. 10, which is a permission based marketing method (1), comprising:
Step 20 creating or opening a data file for a consumer, wherein the consumer includes a request for one or more sellers to make at least one proposal to said consumer to purchase one or more items identified by the consumer;
Step 30 formatting the request from the consumer in the data file of step 20 into a Consumer Advertisement For Proposals (CAFP), wherein at least a fee or other form of compensation is assigned for the opportunity to respond to the Consumer Advertisement For Proposals,
Step 40 offering for sale to one or more sellers, the opportunity to respond to the Consumer Advertisement For Proposals (CAFP) for the assigned fee,
Step 50 identifying sellers who accept the offer in step 40,
Step 60 selling to sellers who accept the offer in step 40 the opportunity to respond to the CAFP for the assigned fee;
Step 70 paying, to said consumer, a portion of the assigned fee paid for each opportunity to respond to the CAFP, and
Step 80 providing the one or more sellers who accept the offer in Step 40 with contact information needed to respond to the CAFP.

The process can end after step 80 or it can end early if there are no sellers who accept the offer made in step 40. An embodiment of this invention includes an additional step where the CAFP is purchased. In this additional step, the consumer, seller or both are provided with an opportunity to provide feedback. The information regarding the consumer is stored in the consumer data file. The information regarding the seller can be stored in certain embodiments where the CAFPs are offered to a limited class of sellers.

The data file can include more than one request from the consumer to purchase items. There is no need to put a limit on the number of requests for the method to function. However, it may be desirable to put a limit on the number of responses when formatting the request from the consumer into a CAFP so that the consumer is not saturated with proposals. Efficient consumers will typically request no more than three proposals for an item where they have named a maximum price.

In another embodiment of the permission based marketing method of this invention, the consumer provides parameters as to when, where and/or how proposals by sellers are to be made to the consumer with the request. The selections can include phone/fax numbers (land line, cell or satellite), internet phone/fax numbers or addresses, video phone numbers or addresses, portal sites on the World Wide Web, e-mail addresses, postal mailing addresses, addresses for virtual post office boxes, and the like. The time of such contacts can be limited to certain days, certain hours, or combinations thereof. How the proposals are delivered can be limited to electronic media, a writing, or an oral presentation via phone or in person. Theses parameters are carried over when the request is formatted into a CAFP.

In an additional embodiment of the permission based marketing method of this invention, data files for a number of consumers are assembled in a database and the CAFPs from this database can be searched for the CAFPs therein. In a preferred embodiment, a database of trusted consumers is assembled based on the consumer's performance in the marketing system. Preferably, the database can be accessed via the World Wide Web (internet), storage media within a computer and/or RAM within a computer, and/or a portable hand-held device such as a phone or PDA. The database may be accessible to (a) the public, (b) Sellers and their agents (such as a Web host or franchise) alone, (c) Consumers and their agents alone (such as a Web host) or (d) combinations of (b) and (c). The database may be accessible to selected sellers or consumers, as determined by a rating system, or selected sellers and/or consumers may be denied access.

In preferred embodiments of the permission based marketing method of this invention, sellers can set parameters (rules) to discriminate between CAFPs when searching a database and the consumers may set parameters (rules) which limit the sellers to which the CAFPs are transmitted to and advertised. The consumer's parameters can discriminate between sellers based on a (1) first-come first served basis or (2) characteristics of the seller such as experience, location, equipment, price, credit rating, a performance rating by a third party accounting firm or consumer organization, or (3) the consumer can block a seller based on identity alone (name). The parameters may also prevent a seller from purchasing a particular CAFP multiple times to ensure the consumer has access to other sellers and is not flooded with proposals from one seller.

In a preferred embodiment of the method of this invention, a seller must be identified either before obtaining access to the Consumer Advertisement For Proposals or before purchasing the opportunity to respond to a Consumer Advertisement For Proposals. The identified seller is preferably assigned a rating. This rating may be dependent on the seller's performance in marketing goods/services according to the rules of the method of this invention as well as the quality of the goods/services that are eventually provided. Such a database may also include identifying data and ratings by consumers. The identified seller may be denied access to certain CAFPs if the consumer, which created the CAFP, so chooses.

Another aspect of this invention is a database of identified sellers with ratings assigned to them based on past performance in the method of this invention. Sellers with low ratings may be segregated from others and denied further participation in the method of this invention, i.e., they will either be denied access to the Consumer Advertisements For Proposals or they will not be permitted to respond to Consumer Advertisements For Proposals.

In a further embodiment of the method of this invention, the particular consumer will be assigned a rating. This rating can be based on reliability and/or buying power of the consumer. These ratings can be determined by the consumer's performance history in purchasing items marketed by the method of this invention. Data regarding the performance history of a consumer can be provided by the sellers directly in a publicly accessible feedback file or purchases can be tracked by a third party intermediary, such as a web host, which then issues the rating. Although the performance history is tracked by a third party, the consumer ratings may still be made available to the sellers in certain embodiments. The reliability ratings can be determined by factors such as the accessibility of the consumer, the consumer's responsiveness to the information, frequency of purchase, age, location or other information. Seminars may be offered to help consumers improve their rating, particularly for those consumers that violate the rules of this marketing method. These courses can vary widely in content and format and can include those very much like driver's education courses taught to violators. When proof of attendance of one or more courses has been provided, the consumers' rating is increased or restored to a previous level. However, if the consumer continues to violate the rules, taking the courses will not affect the consumer rating. The buying power will include factors such as credit rating and income.

In an embodiment of the permission based marketing method of this invention, the portion of the price paid to the consumer for the opportunity to make a proposal is determined by these ratings. In preferred embodiments, these ratings will be able to vary between particular markets.

Another aspect of this invention is a database of identified consumers with ratings assigned to them based on their performance history in the method of this invention. Consumers with a low rating may be segregated from others and denied further participation in the method of this invention, i.e., they will be denied access to the web site or have restricted access.

A further aspect of this invention is a database of identified sellers. Sellers with a low rating may be segregated from others and denied further participation in the method of this invention, i.e. they will be denied access to the database of CAFPs.

The consumer will withdraw/remove the request in the database if the demand for the item has been satisfied or is terminated for other reasons. In preferred embodiments, this will result in the withdrawal of the CAFP. In certain embodiments, the consumer will not be able to remove a request from the database or CAFP without penalty once a seller has paid the fee for the CAFP. In other embodiments, the consumer can state in the feedback section as to why the CAFP was withdrawn. If the seller agrees the consumer provided an adequate reason, the sellers may allow the consumer to keep the fee. In addition, where a consumer has a specific request to buy and the seller's proposal meets all of the consumer's requirements yet the proposal is rejected and no reasons is offered why, a penalty may apply and the consumer's rating reduced.

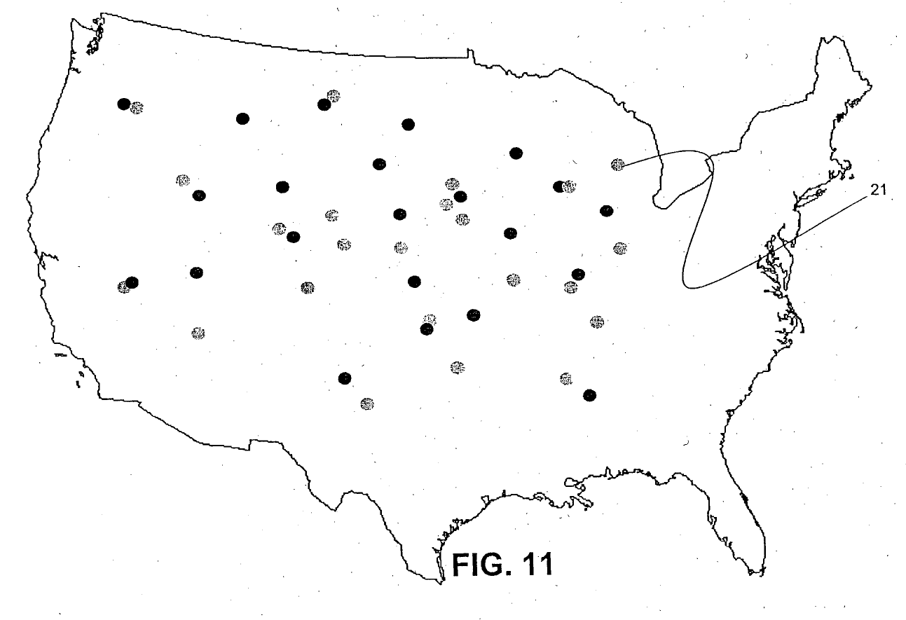

In a more preferred embodiment of the method of this invention, the CAFP is given a start date and an automatic expiration date for a predetermined time after the start date, which is preferably less than one month. In another preferred embodiment of the method of this invention, the sale of the good or service of interest is monitored and once the sale is complete, the request by the consumer is removed from the database and the CAFP is withdrawn immediately thereafter. In another embodiment, the CAFP may be hidden from the searches after the sale of the CAFP is complete and deleted from the database after the sale of the item is complete. The prompt removal of the CAFP allows sellers to mine for consumers. In another embodiment of the method of this invention, the demand for a particular item can be output in real-time based on data within the database. This is shown in FIG. 11, which is a map of the general location of selected Consumer Advertisements For Proposals in the lower 48 states of the United States. The map can increase or decrease in size in a manner analogous to the software MapQuest®. Each dot 21 represents a Consumer Advertisement For Proposals. The level of detail that is output as to the location and number of Consumer Advertisements For Proposals can vary as is necessary for the seller to commit to purchasing the opportunity to respond to the them. In an embodiment of this invention, the map of the consumer will display data shown to a zip code but not a street. The host will have contact information at the street level. The map with information real-time may be available as a separate fee.

Sellers can purchase consumer information based on reliability ratings, purchase power or other identifying characteristics set forth in the consumers file within the database. In a preferred embodiment, consumers can be targeted by their location, reliability, purchasing power, consumer's age, the number of CAFPs already accepted, the age of the request, etc. In a preferred embodiment, refunds are provided to sellers where the consumers can not be contacted when the conditions are followed. In another embodiment, penalties are issued to the consumer that can not be reached or displays clear avoidance intentions to communicate as directed by the consumer in their CAFP to sellers. These consumers will get low ratings or be removed from the network.

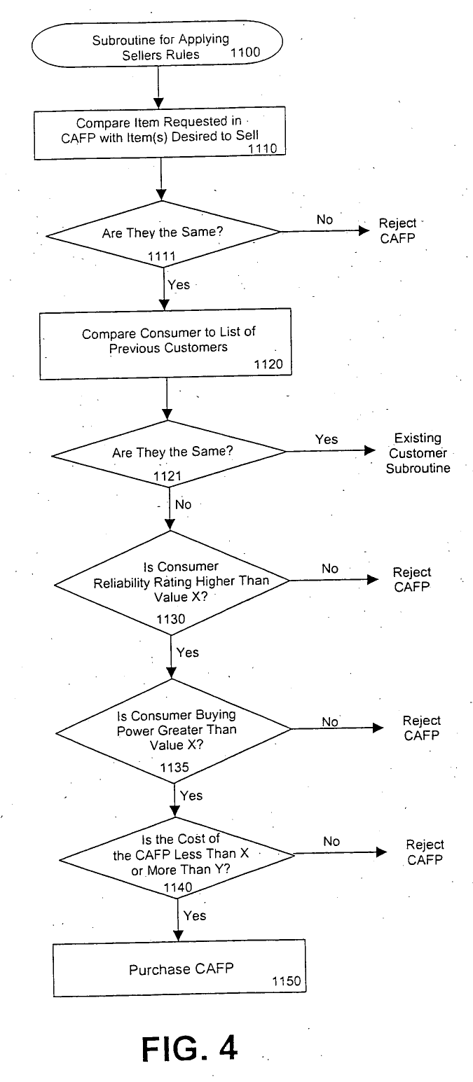

In another embodiment of the method of this invention, Consumer Advertisements For Proposals of interest are targeted and identified by parameters set by a third party, such as a franchise or licensee. These parameters may be proprietary. A franchise can apply a proprietary subroutine as shown in FIG. 4 to identify Consumer Advertisements For Proposals of interest.

The sellers contact the consumers to make the proposal under any conditions specified in the consumer's data field. This marketing method benefits the consumers, allowing them to control when and where and the number of marketing messages targeted at them and be paid for their time as well. It also provides consumers with an opportunity to do business with entrusted sellers with a reputation that has been tested. The marketing method also benefits the sellers in that they contact a willing, credible consumer in a non-confrontational environment and spend less time looking for consumers that want their product/services. They receive access to non-published numbers, break through call-screening barriers, and are no longer susceptible to the no-call list dilemma.

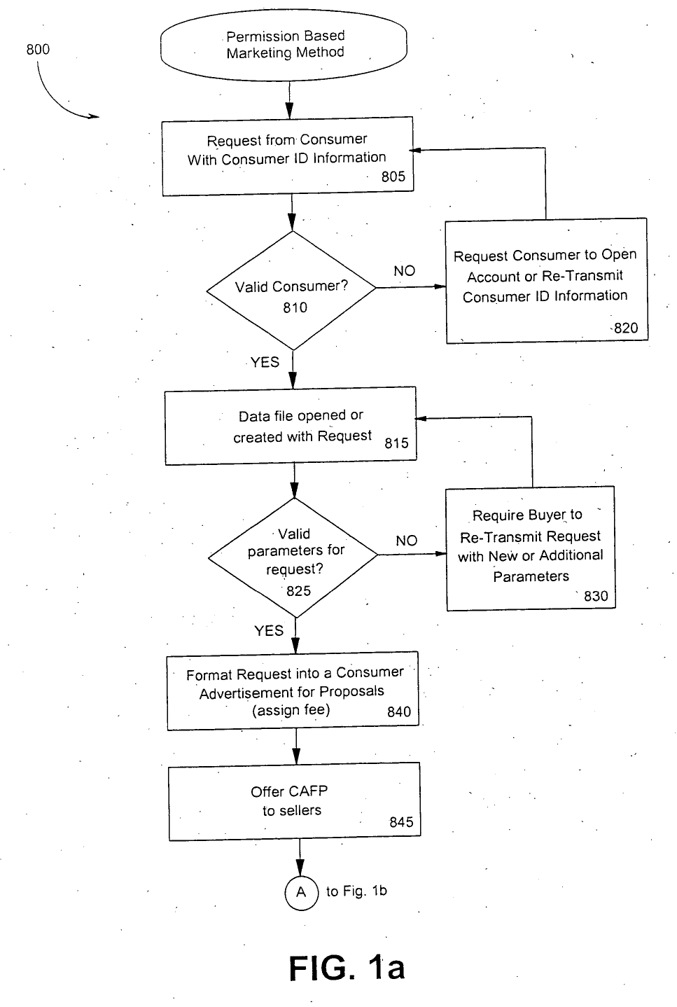

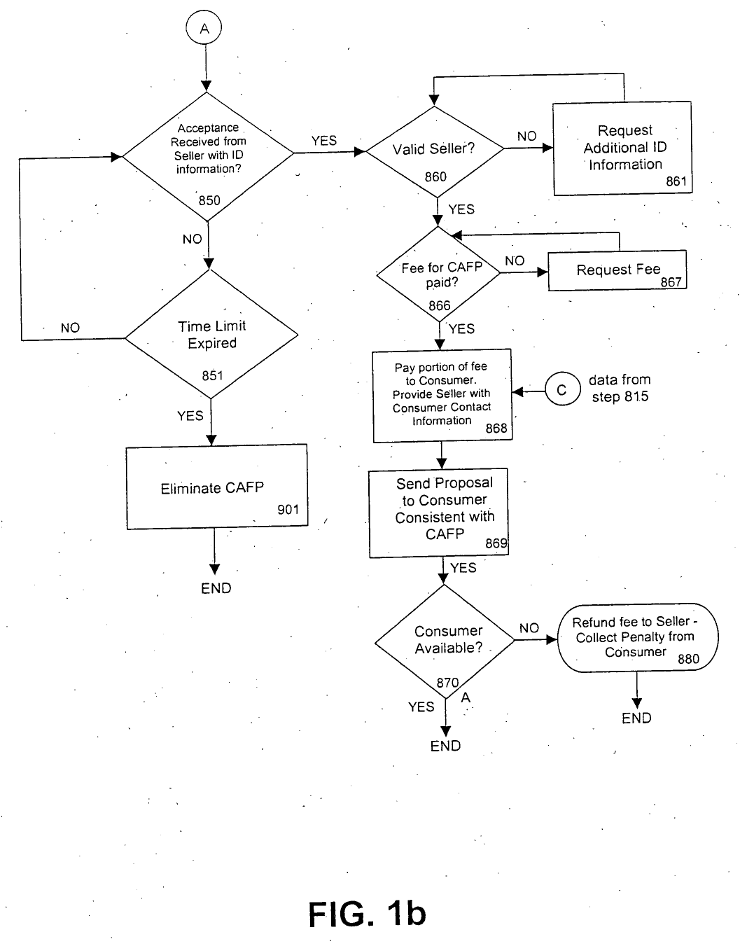

A preferred permission-based marketing method of this invention will now be described in detail with reference to FIGS. 1a and 1b. The permission-based marketing method 800 begins at step 805 of FIG. 1a where a consumer submits identifying information, preferably a consumer account number and password, with a request to one or more sellers to sell an identified item (good or service). The consumer identification information, preferably an account number and password, is evaluated in step 810 to determine if the identifying information is valid, i.e., whether or not the password and account number are correct. In some embodiments of this invention, the status or rating of a properly identified consumer may be reviewed before access is provided. A consumer in poor standing will be denied access and will be given instructions on how to improve their standing. If it is determined that the consumer is not adequately identified, e.g., the account number and password provided are wrong or not provided at all in the case of a new consumer, the consumer is requested to retransmit the request with the proper identifying information or open an account with the necessary identifying information.

Once the proper consumer identifying information is provided, e.g., the password and account number are verified, a data file for the consumer is opened or created in step 815. The parameters of the request, i.e., the items requested and the conditions of when, where and how the proposals are to be made, are evaluated in step 825 to determine whether or not it is a valid request. If it is determined that one or more parameters in the request is not valid, the consumer is requested to retransmit the request with new or additional parameters in step 830. The request is returned to the Consumer if, for example, the goods and services requested are illegal to sell or if the conditions for making the proposal are impossible to fulfill. This can occur if the request erroneously prescribes contact dates which have already passed or if the consumer requests an item/service at zero cost. If the consumer is requested to resubmit the request, the new request is evaluated again in step 825.

When the parameters of a request are found to be acceptable, the request is processed into a Consumer Advertisement For Proposals (CAFP) in step 840, wherein at least a fee or other form of compensation or remuneration for responding to the request is assigned subject to the supply and demand for that consumer. In forming a CAFP, the request is preferably formatted and assembled with other requests into CAFPs for transmission to sellers.

In step 845, the CAFP is transmitted to sellers by either electronic mail, facsimile transmission, regular mail or by posting on a web page or in a database available to seller for data mining. In a preferred embodiment, transmission of the CAFP is accomplished by simply storing the CAFP on a searchable database which can be accessed via the World Wide Web or closed network, WiFi, PDA, video or cell phone.

In step 850, it is determined whether an acceptance is received from one or more sellers. In step 860, the acceptance is processed to identify the seller. If the seller is not identified, the seller is contacted in step 861 to provide further information. In an embodiment of this invention, identified sellers may be rated by past performance under the method of this invention by consumers. If the seller does not have a satisfactory rating, access to the CAFPs may be denied or they may not be given access to purchase the opportunity to respond to the CAFPs. Means by which the sellers can improve their rating may be offered such as making restitution with consumers, purchasing a bond, taking online courses or having books evaluated by an accounting firm. Where the seller has been identified, and in some embodiments, determined to be in good standing, the acceptance is processed for payment of the requisite fee in step 866. If payment has not been included or arranged, a request to the seller to complete payment of the fee is made in step 867. In a preferred embodiment, the acceptance from the seller may provide a payment identifier (account number and password) for the seller's general purpose account that can be charged automatically. An alternative to completing payment is to query a remote authorization service to verify that sufficient funds are available to cover the fee for the CAFP in a general purpose account outside of the system.

If the fee for responding to the CAFP is received, in step 868 the seller is provided with the consumer's contact information set forth in the data file of step 815. This includes sufficient information to make the proposal, such as an e-mail address, mailing address, telephone number, facsimile number, etc. and may optionally include the consumer's name or an identification number. The consumer's preferred contact method can be displayed to the sellers prior to purchase of the CAFP. This prevents the seller from paying for a CAFP that can only be contacted two minutes out of every day. In addition, a portion of this fee may be paid to the consumer at this time. This can be done by crediting a general purpose account held by the consumer.

If the consumer has been paid in step 868, the following steps are optional in the context of the method of this invention. The performance of these steps will be dependent on the actions, discretion and motivation of individuals outside of the system provided by this invention. However, it is anticipated that these steps will be preformed substantially all of the time.

In step 869, the seller sends the proposal to the consumer consistent with the parameters set forth in the CAFP. If the seller does not send the proposal, the process ends if the seller has paid for the CAFP. In a preferred embodiment, the system will track whether the proposal was received or not by conventional means such as e-mail tracking, UPS tracking and FedEx tracking.

In step 870, it is determined whether or not the consumer is available consistent with the conditions set forth in the CAFP. If the consumer has followed through and is available to receive the proposal, the process ends with a portion of the fee having been credited to the consumer's account. If the consumer is not paid for the CAFP in step 868, the fee is paid to the consumer or credited to an account before the process ends. If the consumer has not been available, the fee previously paid for the CAFP is refunded to the seller and optionally, a penalty is collected from the consumer in step 880. The process then terminates in step 900 along path A. In an alternative embodiment, the debits and credits will remain in an Escrow account for a full 30 days prior to disbursement. This allows for refunds and corrective measures to be taken before distribution to the consumer.

In a preferred embodiment, the performances of the consumer and seller are each evaluated by the other or a third party. The evaluation for the consumer is added to the data file of step 810 which is used to identify the consumer and determine the percentage of the fee to be returned to the consumer. The evaluation of the seller is added to the data file in step 860.

If in step 850, it is determined that the CAFP has not been accepted by at least one seller after a predetermined period of time as determined in step 851, the CAFP is eliminated in step 901 and then the process terminates. In certain embodiments it is preferable that the CAFP be eliminated after about one month. The CAFP may be eliminated even if acceptances have been received. In an embodiment of this invention, not shown in FIGS. 1a or 1b, the consumer may be informed or warned of the elimination of the CAFP such that a new request can be submitted. The goal of such an embodiment is to provide CAFPs real-time. The CAFP is also removed upon the fulfilling of the demand.

As indicated above, the acceptance sent by the seller may include a payment identifier (account number and password) for a general purpose account -to guarantee payment for CAFPs. The consumer may also have a general purpose account to receive payments for the CAFPs sold and to charge for any penalties.

In another embodiment, where a consumer uses a credit card to make a purchase for which a CAFP is outstanding and the credit card company provides online access to account activity, the account activity can be linked back to the consumers personal data file to automatically reflect the “fulfillment” of the demand set forth in the CAFP. For example, where a consumer has opened a CAFP for a television and (a) this television is purchased by the consumer using a credit card with on line account access and (b) the purchase matches the consumer's CAFP for a television, the method of this invention will show that the demand set forth in the CAFP has been met.

Consumers within their preferences may select to receive broad-based marketing methods such as Spam for a fee, such as, for example, ½ cent, even if they have no intention to purchase. Such Spam will be safer and virus free.

It is desirable in one embodiment of the present invention to include a feature that prevents consumers from submitting multiple CAFPs for a given item. This would result in multiple fees for contacting the same consumer, undermining the efficiency of the method of this invention. The submission of multiple requests by a consumer can be minimized by requiring the consumer to complete a purchase of goods or services for which the Consumer Advertisement For Proposals was directed before fees can be received from purchased CAFPs. This should discourage consumers from opening duplicate accounts when only one item or service is desired.

Another method of discouraging multiple CAFPs includes a compare program wherein each CAFP can be compared to others within the system to determine if similar requests have been made. For example, repetitive CAFPs changing only a mailing address or e-mail address to receive any proposal may be blocked by the system. Alternatively, the CAFP may have general purpose accounts attached to them. Each general purpose account has a social security number. The compare program can prevent multiple general accounts under the same social security number. This helps eliminate the reward for such behavior. Repetitive CAFPs can also be a-voided by requiring the consumer fill out a questionnaire in response to each proposal received by the seller. In one embodiment, subsequent CAFPs by the same consumer are accepted as proper requests in step 825 only if there is some substantial change in the request that would result in the request being made to an essentially different product. This would include repeat purchases such as a weekly pizza.

It is also desirable in another embodiment of the invention that the consumer's identities are maintained anonymous within the permission-based marketing system until at least a CAFP is accepted, preferably at all times. Such identity anonymity allows consumers to participate in the permission-based marketing system without fear of being contacted with proposals outside of the permission-based marketing system.

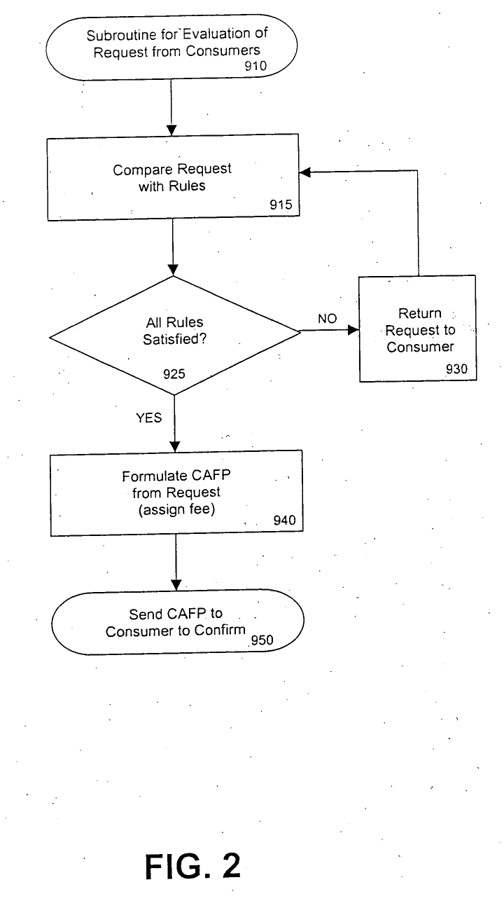

To determine whether a request from a consumer is valid, the request is compared with predetermined rules. FIG. 2 illustrates a subroutine for evaluation of requests 910 where the item and parameters identified in the request are compared with predetermined rules in step 915. If all of the rules are not satisfied in step 925, the request is returned to the consumer in step 930. If all of the rules are satisfied, a CAFP is formulated from the request in step 940, assigning at least a fee for the CAFP. The CAFP is then sent to the consumer in step 950 as confirmation.

Some acceptable parameters for the request from the consumer may include specific dates and times for receipt of the proposals and in addition, a suitable parameter for the request may allow a consumer to specify one or more preferred sellers.

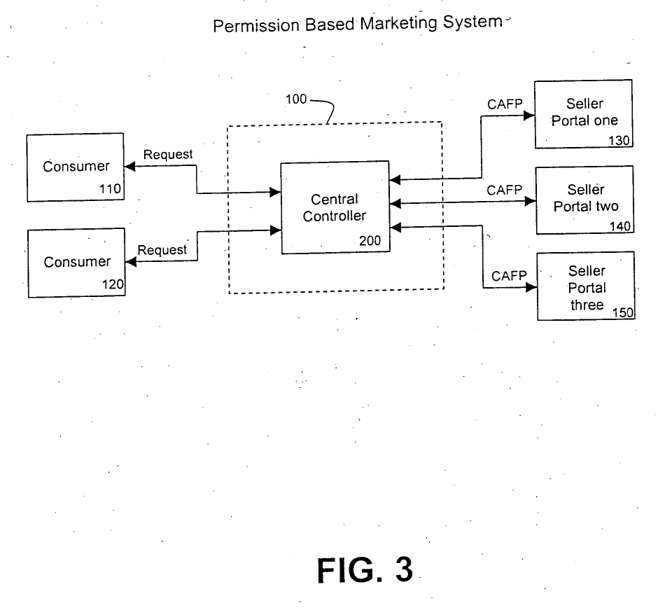

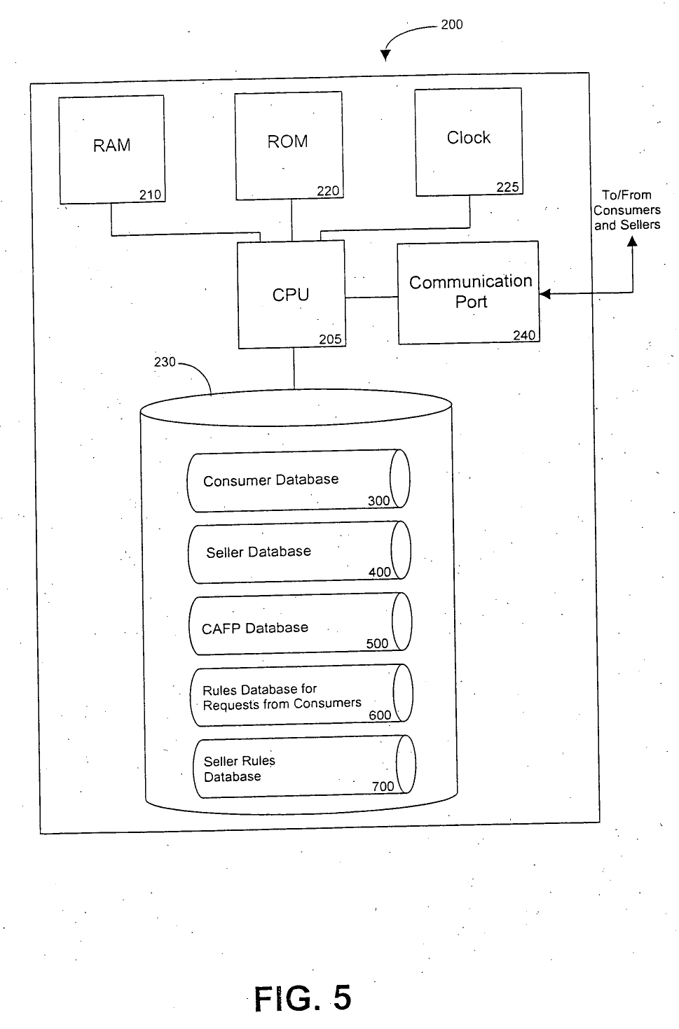

In another aspect of the present invention, there is provided a permission-based marketing system which receives requests from consumers and processes the requests into Consumer Advertisements For Proposals (CAFPs) as described above. FIG. 3 shows the permission-based marketing system 100 for receiving and processing the requests from one or more consumers via consumer portals 110 and 120. The permission-based marketing system 100 processes these requests into Consumer Advertisements For Proposals (CAFPs) wherein at a minimum, a fee is assigned for the opportunity to respond to the request by central controller 200, further discussed below in conjunction with FIG. 5. Optionally, central controller 200 also assembles and formats a number of requests into CAFPs for transmission to one or more sellers at seller portals 130, 140 and 150. When a seller accepts a given CAFP, the acceptance is preferably sent to central controller 200 of the permission based marketing system 100 from portals 130, 140 and 150. The permission-based marketing system preferably binds the seller to pay for the CAFP and provides the consumer a portion of the fee paid. The fees paid to the Consumer can be deposited in a general purpose account and the deposits are communicated to consumer portals 110 and 120.

The permission-based marketing system 100 may be selective in transmitting a given CAFP to sellers at portals 130, 140, 150 so that sellers only obtain CAFPs that they are interested in or are authorized to screen. Alternatively, the permission-based marketing system 100 may provide all CAFPs to all sellers at portals such as 103, 140 and 150 for screening on their own. Access to purchase CAFPs may still be restricted and dependent on the seller's rating.

As discussed further below, each consumer contacts the permission-based marketing system 100 through a portal such as consumer portals 110 and 120 by means of a telephone, facsimile, PDA, video, online access, i.e. World Wide Web, electronic mail, personal contact, or through an agent, and provides the permission-based marketing system with the terms of the consumer's request. It is noted that each consumer portal 110 and 120 and seller portal 130, 140 and 150 may comprise a general purpose computer for communicating with the permission-based marketing system. The general purpose computer is preferably comprised of a processing unit, modem, memory means, network capabilities and any software required to communicate with the permission-based marketing system 100.

The permission-based marketing system 100 and any general purpose computer which comprises consumer portal 110 or 120 or seller portal 130, 140 or 150, preferably transmit digitally-encoded data and other information between one another. The communication links between the portals preferably comprise a conductive cable, optical fiber or wireless link on which electronic signals can propagate. The permission-based marketing system can preferably provide one or more CAFPs to each seller at seller portals 130, 140 and 150 including PDAs and cell phones. It is noted that the permission-based marketing system 100 can provide a CAFP to each seller at seller portals 130, 140 and 150 including PDAs and cell phones by means of a broadcast transmission, or by means of posting the CAFP, for example, on an electronic bulletin board accessible by each seller via their computers which are part of portals 130, 140 and 150. Alternatively, the permission-based marketing system 100 can evaluate one or more CAFPs against a number of seller's rules administered by and applied by the web host, either directly or through a franchise, to determine if a certain CAFP should be transmitted to the sellers computers at portals 130, 140 or 150. An illustrative set of seller's rules applied by a web host is set forth in FIG. 4 discussed in more detail below. In an embodiment of this invention, the sellers rules can be applied by a third party franchise or licensees and remain confidential.

FIG. 4 illustrates an example of a subroutine 1100 for applying seller's rules in purchasing a CAFP. It should be recognized that this subroutine can vary significantly from seller to seller and even a particular seller may modify the routine extensively for different goods and services. In step 1100, the item requested in the CAFP is compared to items available. If there is no match, the CAFP is rejected in step 1111. If there is a match, further rules are applied, such as comparing the consumer to a list of previous customers as in step 1120 and rejecting the CAFP in step 1121 based on an undesired outcome. Other tests in subroutine 1100 are the consumer's reliability rating 1130, the consumer's buying power 1135 or whether the cost of the CAFP 1140 is reasonable. Other tests can be included depending on the seller's needs. For example, not shown in subroutine 1100 of FIG. 4 is a test of whether the preferred method of contact is reasonable. If all parameters are meet, the CAFP is purchased in step 1150. The present invention includes embodiments wherein the subroutine is performed by or on behalf of a franchise or licensee, either in the same location using the same equipment where other steps in the method of this invention are performed or at a remote location with distinct equipment.

In one embodiment of the permission-based marketing system 100 of this invention, central controller 200 comprises at least one communication port (not shown in FIG. 3) through which requests from consumers can be received from consumer portals 110 and 120. In a preferred embodiment, CAFPs processed by the central controller are transmitted to sellers through this communication port (not shown in FIG. 3). More preferably, the acceptances of CAFPs by sellers are received through this communication port.

FIG. 5 is a block diagram showing the architecture of an illustrative central controller 200 with one communication port 240. The central controller 200 also preferably includes certain standard hardware components such as a central processing unit (CPU) 205, random access memory (RAM) 210, a read-only memory (ROM) 220, a clock 225 and a data storage device 230. The CPU 205 is preferably linked to each of the other listed elements either by means of a shared bus or dedicated connections as shown in FIG. 5. A communications port 240 connects the central controller 200 to each consumer portal 110 and 120 and seller portals 130, 140 and 150. The communications port 240 preferably includes multiple communication channels for simultaneously establishing a plurality of connections. The ROM 220 and/or data storage device 230 are configured and programmed to store databases and commands which the CPU 205 is operable to retrieve, interpret and execute. For example, the ROM 220 and/or data storage device 230 preferably store processes to accomplish the transfer of required payments, charges and debits between sellers at portals 130, 140 and 150 and consumers at portals 110 and 120. The processing of such accounting transactions are preferably secured in a conventional manner, for example, using well-known cryptographic techniques.

The data storage device 230 includes a consumer database 300 and a rules database for requests 600 and a CAFP database 500. The data storage device 230 optionally also contains a seller database 400 and a seller rules database 700. The system can perform without a seller database or seller's rules database. The seller's rules database can also be stored within a separate data storage device at a remote location, such as where the seller's rules are proprietary to a third party franchise.

The consumer database 300 preferably stores information on each consumer of the permission-based marketing system 100 which can include identification information, contact information, accounts information, performance history and a rating.

The rules database for requests contains parameters to which conditions within requests from the consumer are compared. The rules within this database determine whether the request from the consumer is valid and can be processed into a CAFP.

The seller database 400 preferably stores information on each seller which is registered with the permission-based marketing system 100 to receive proposals from consumers as well as billing information. As indicated above, an embodiment of this invention is a database wherein identified sellers assigned a rating based on their performance history with the method of this invention.

The CAFP database 500 preferably contains a record of each CAFP processed by the permission-based marketing system including the conditions associated with the CAFP (product it applies to and parameters for the proposal) and the associated status (number of acceptances and age).

The sellers rules database 700 as exemplified in FIG. 4, maintains the rules for purchasing CAFPs by one or more sellers. The rules database contains a number of records associated with each seller. The terms and conditions by which CAFPs are screened prior to transmission to any particular seller are applied before transmission. These can include limitations as to the location of the consumer, the number of items requested or the purchasing power of the consumer.

Also provided by this invention is a portal site for the World Wide Web which comprises storage media for storing an electronic database on a World Wide Web portal site and a processor for searching, sorting -and indexing information within the electronic database, accessed through the World Wide Web.

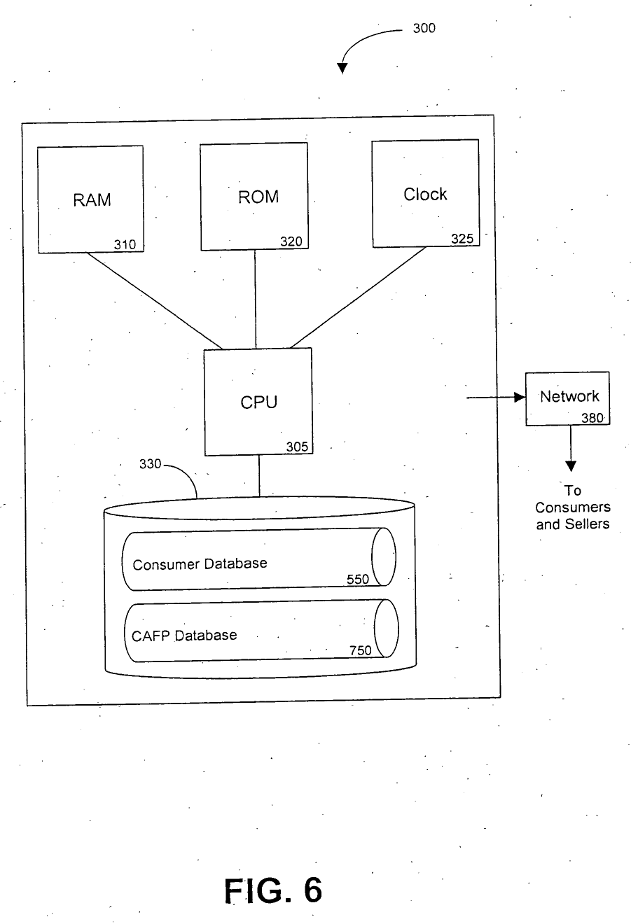

FIG. 6 illustrates portal site 300. The CPU 305 functions as a processor for searching, sorting and indexing the information within the electronic database accessed through the World Wide Web. RAM 310, ROM 320 and clock 325 aid in processing this information.

Storage media 330 includes consumer database 550 of individual consumers accessible by the World Wide Web and a database of Consumer Advertisement For Proposals (CAFPs) 750 from these individual consumers accessible by the World Wide Web. The consumer database 550 includes at least one data file corresponding to each consumer with contact information for the consumer and optionally the identity of the consumer. Optionally, the consumer database may contain information regarding the consumer's proposals which were formatted into CAFPs. The consumer records can be stripped and then used to provide generic reports to illustrate demand for any specific product or service and can be resold to firms that may be able to use such data.

The portal site can be connected to the World Wide Web via an external communication port 380, such as that within a network, to enter information into the electronic database through the World Wide Web and retrieving information from this portal site via the World Wide Web.

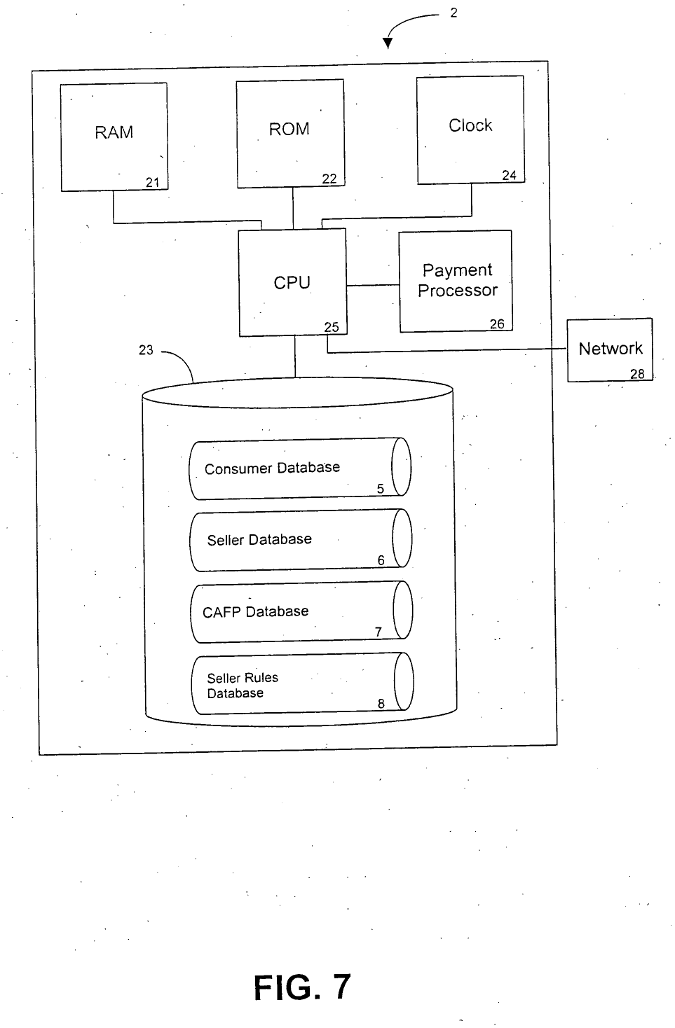

Another embodiment of a portal site 2 of this invention is shown in FIG. 7, which includes RAM 21, ROM 22, storage media 23, Clock 24, CPU 25 and payment processor 26. Here the storage media 23 includes an electronic database of individual consumers 5, individual sellers 6, a CAFP database 7, optionally a sellers rule database 8, optionally an accounts database 9 (not shown) for processing payments through payment processor 26. The network interface 28 provides access to the World Wide Web.

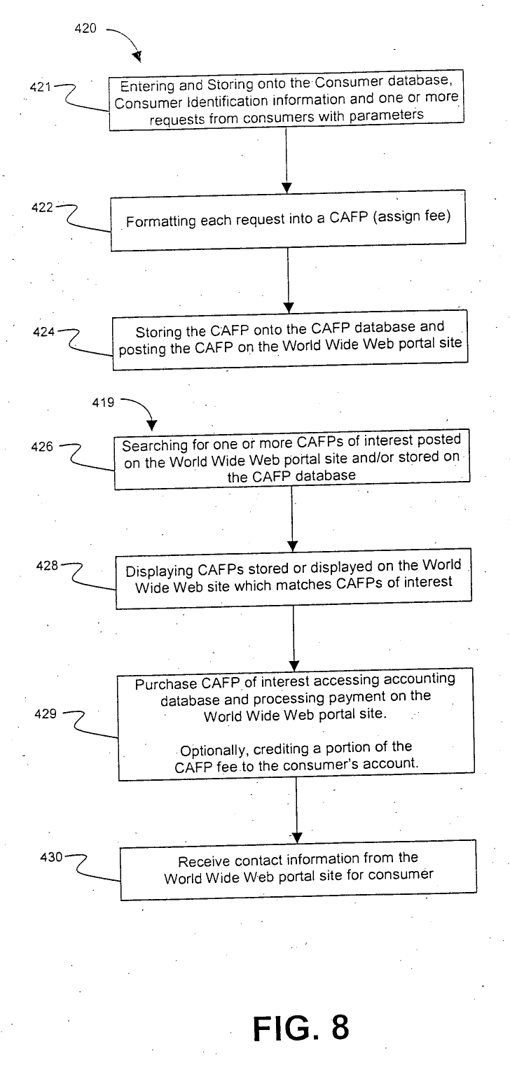

There is also provided a method 420 for a consumer to interact with a portal site as shown FIG. 8. Method 420 comprises the steps of

421, entering and storing information onto the consumer database of the World Wide Web portal site which includes consumer identification information, e.g., an account number and password, and one or more requests with parameters for each proposal,

422, formatting each request into a CAFP with processor 205, wherein at least a fee is assigned to said CAFP, and

424, storing the CAFP onto the CAFP database of the World Wide Web portal site and optionally posting the CAFP on the World Wide Web portal site. This method of interaction 420 is from a consumer's perspective. A preferred embodiment of this method permits a consumer may optionally interact with step 424 to amend or remove CAFPs stored or posted.

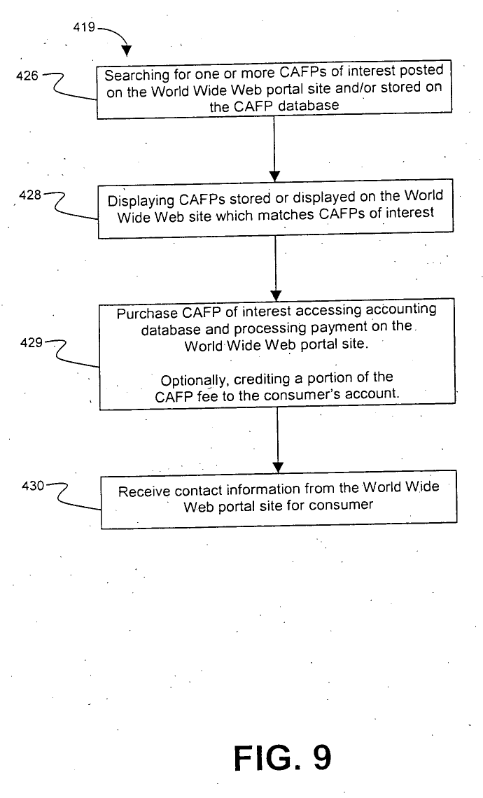

There is also provided a method 419 for interacting with a portal site from the perspective of a seller, consumer or any member of the general public, shown in FIG. 9. Method 419 comprises the steps of

426, searching the information posted on the World Wide Web portal site and/or stored in the CAFP database for CAFPs of interest; and

428, displaying CAFPs posted on the World Wide Web portal site and/or stored in the CAFP database which match CAFPs of interest. Preferably, the CAFPs displayed are current to within 24 hours; most preferably, they are current to within an hour or less.

A preferred embodiment of method 419 includes the additional step 429 of purchasing a CAFP of interest by accessing the accounting database and processing payment on the World Wide Web portal site. A further preferred embodiment includes the additional step 430 of receiving contact information from the World Wide Web portal site for the consumer to make the proposal following payment. In a further preferred embodiment, in step 429, the consumers account is credited with a portion of the purchase price for the CAFP at the time of payment.

Without further elaboration, it is believed that one skilled in the art can, using the preceding description, utilize the present invention to its fullest extent. The entire disclosure of all applications, patents, publications, cited above and below, are herein incorporated by reference.

The preceding embodiments can be assembled with similar success by substituting the generically or specifically described components and/or process conditions of this invention for those used in the preceding examples. From the foregoing description, one skilled in the art can easily ascertain the essential characteristics of this invention, and without departing from the spirit and scope thereof, can make various changes and modifications of the invention to adapt it to various usages and conditions.

The entire disclosures of all applications, patents and publications, cited herein and of corresponding U.S. Provisional Application Serial No. 60/634,821, filed Dec. 20, 2004, are incorporated by reference herein.

1. A method for marketing an item which comprises:
(a) creating or opening a data file for a consumer, wherein the consumer includes a request for one or more sellers to make at least one proposal for said consumer to purchase one or more items identified by the consumer;
(b) formatting the request from the consumer in the data file of step (a) into a Consumer Advertisement For Proposals (CAFP) wherein at least a fee or other compensation or remuneration is assigned for the opportunity to respond to the Consumer Advertisement For Proposals (CAFP),
(c) offering for sale to one or more sellers, the opportunity to respond to the Consumer Advertisement For Proposals (CAFP) for the assigned fee, compensation or remuneration,
(d) identifying sellers who accept the offer in step (c),
(e) selling to sellers who accept the offer in (c), the opportunity to respond to the Consumer Advertisement For Proposals (CAFP) for the assigned fee, compensation or remuneration; and
(f) paying, to said consumer, a portion of the assigned fee, compensation or remuneration paid for each Consumer Advertisement For Proposals (CAFP), and
(g) providing the sellers who accept the offer in step (c) with contact information needed to respond to the Consumer Advertisement For Proposals.

2. A method as in claim 1, wherein the CAFP includes parameters as to when, where and/or how a proposal is to be made to said consumer.

3. A method as in claim 2, wherein the proposals for a number of consumers are formatted into a CAFP and stored in a database and said database can be searched for the CAFPs therein.

4. A method as in claim 3, wherein the database can be searched for multiple CAFPs to make multiple proposals.

5. A method as in claim 4, wherein access to the database where the CAFPs are stored is via the World Wide Web, storage media within a computer, RAM within a computer, a portable handheld PDA or phone.

6. A method as in claim 4, wherein sellers and consumers are rated and only sellers and their agents and/or consumers and their agents of a sufficient rating can search the database for CAFPs.

7. A method as in claim 6, wherein the sellers and their agents and/or consumers and their agents set parameters to discriminate between CAFPs.

8. A method as in claim 7, wherein the consumer sets parameters to limit the number of sellers which are given the opportunity to make proposals.

9. A method as in claim 1, wherein a consumer is assigned a rating and the portion of the fee paid by the consumer for his CAFP is dependent on said rating.

10. A method as in claim 9, wherein the rating assigned to a consumer is determined by the consumer's performance history with respect to this method of marketing.

11. A method as in claim 10, wherein the rating assigned to the consumer is also determined by the consumer's buying power.

12. A method as in claim 1, wherein the CAFP is removed from the database or hidden from searches automatically after a given time from a start date expires, when the demand for the item has been satisfied or the CAFP is removed before the step of paying, to the consumer, a portion of the fee, compensation or remuneration for the CAFP.

13. A method as in claim 1, wherein the active CAFPs are displayed by location on a map in real time.

14. A method as in claim 1, wherein a consumer can remove a CAFP before the step of paying, to the consumer, a portion of the fee, compensation or remuneration for the CAFP.

15. A method as in claim 2, comprising the additional steps of (h) making a proposal to sell said item to said consumer by one or more sellers and (i) rating the seller's performance by the consumer and storing the information in a database.

16. A method as in claim 14 comprises the additional step of (j) rating the consumer's performance by the seller and storing the information in a database.

17. A system for marketing an item comprising
(a) one or more communications ports to receive, from a consumer, a request from a consumer for one or more sellers to sell a particular item to said consumer, wherein said request from said consumer contains a description of said item, information which identifies the consumer, and any parameters that are necessary for sellers to make the proposal;
(b) one or more processors to format and assemble individual requests for said particular item, and assign a fee, compensation or remuneration for the opportunity to respond to each individual request for said particular item, and form a CAFP, and
(c) a storage medium which stores databases with consumer information, information regarding CAFPs, and optionally a seller's database, a consumer's rule's database for requests, and a seller's rules database.

18. A system as in claim 16, further comprising a port to receive acceptances of CAFPs.

19. A method of interacting with a World Wide Web site portal having a database of CAFPs from consumers to purchase particular items, said method comprising the steps of:
(a) entering and storing onto the database of the World Wide Web portal site, consumer identification information and one or more requests to sell a particular item to said consumer;
(b) formatting each request from a consumer into a CAFP, which includes assigning a fee, compensation or remuneration to the CAFP;
(c) storing the CAFP onto a database on the World Wide Web portal site or posting the CAFP on the World Wide Web portal site.

20. A method of interacting with a World Wide Web portal having a database of CAFPs from consumers, said method comprising the step of sending for one or more CAFPs of interest posted on the World Wide Web portal site and/or stored on the CAFP database.

21. A method as in claim 19, further comprising the step of displaying CAFPs stored or posted on the World Wide Web site which match CAFPs of interest.

22. A method as in claim 19, wherein a consumer interacts with the site from a remote location by adding or deleting CAFPs.

23. A method as in claim 20, comprising the additional step of purchasing the CAFP of interest by accessing an accounting database and processing payment on the World Wide Web portable site.

24. A method as in claim 21, wherein the purchaser of the CAFP receives contact information for the consumer from the World Wide Web portal site.

25. A portal site for the World Wide Web which comprises:
(a) an electronic database of individual consumers accessible by the World Wide Web, and an electronic database of Consumer Advertisements For Proposals (CAFPs) from these individual consumers;
(b) a communication port for entering information to the electronic databases solely through the World Wide Web, said information including data regarding the identity of a consumer and information regarding requests for one or more proposals for the consumer to purchase selected items;
(c) a processor for searching, sorting and indexing the information within the electronic database accessed through the World Wide Web; and
(d) storage media for storing the electronic database on a World Wide Web portal site.

26. A portal site as in claim 24, which additionally contains a communication port for entering information to electronic databases outside of the World Wide Web.

27. A digital storage medium which contains a database of
a) consumers rated by their past performance using the method and system of this invention,
b) sellers rated by their past performance using the method and system of this invention, or
c) both a) and b).
